(19) United States
(12) Patent Application Publication
(10) Pub. No.: US 2014/0091113 A1
(43) Pub. Date: Apr. 3, 2014

(54) Ice Slurry Delivery System and Components Thereof

(71) Applicants: Graham Brewster, Hamilton (NZ); Paul Laursen, Hamilton (NZ); Lincoln Sell, Hamilton (NZ)

(72) Inventors: Graham Brewster, Hamilton (NZ); Paul Laursen, Hamilton (NZ); Lincoln Sell, Hamilton (NZ)

(21) Appl. No.: 14/032,397

(22) Filed: Sep. 20, 2013

(30) Foreign Application Priority Data
Sep. 20, 2012 (NZ) 602543

(51) Int. Cl. B67D 3/00

(52) U.S. Cl. CPC F16K 21/00
USPC 222/525; 222/183

(57) ABSTRACT

The current invention relates to an ice slurry delivery system including a bottle, a valve including a conduit defining an inlet port and an outlet port, wherein the inlet port and outlet port are each adapted to provide one or more openings, at least one opening at each port having a cross sectional area of at least substantially 80 mm², and a stopper portion, wherein the stopper portion and conduit move relatively between a stopped configuration, in which the inlet port is in sealing contact with the stopper portion, and an open configuration, in which the inlet port is removed from the stopper portion to provide a fluid pathway of at least 80 mm² between the stopper portion and the inlet port; and a lid adapted to connect directly or indirectly to the bottle and wherein the lid is adapted to receive at least a portion of the valve to provide a fluid pathway between a first side of the lid and a second side of the lid.

### REFERENCE TO RELATED APPLICATION

This application is based upon and claims the benefit of priority from the corresponding New Zealand Patent Application No. 602543, filed in the Intellectual Property Office of New Zealand on Sep. 20, 2012, the entire contents of which are incorporated herein by reference.

### TECHNICAL FIELD

This invention relates to an ice slurry delivery system and components thereof. More specifically, the invention relates to a delivery system including a valve, a bottle and a lid for delivering particulate ice slurry.

### BACKGROUND ART

The consumption of a particulate ice slurry or ice slushy beverage has been shown to be more effective at lowering thermal strain and increasing endurance exercise performance in the heat, even compared with cool liquids (Siegel & Laursen, 2012). Therefore, there is considerable advantage for athletes competing in the heat if they consume an ice slushy beverage before and during exercise.

Current water-bottle design is not effective for delivering ice slurry to a user. Ice slurry inserted into a standard water bottle will congeal into clumps and only exit the bottle in its liquid form after melting; the ice content being too large to get through the spout, or blocking the valve components in the lid.

Further, current bottle design offers poor insulation and internal contents melt quickly in hot conditions.

It is an objective of the present invention to address the foregoing problems or at least to provide the public with a useful choice.

Throughout this specification, the word “comprise”, or variations thereof such as “comprises” or “comprising”, will be understood to imply the inclusion of a stated element, integer or step, or group of elements, integers or steps, but not the exclusion of any other element, integer or step, or group of elements, integers or steps.

Further aspects and advantages of the present invention will become apparent from the ensuing description, which is given by way of example only.

### SUMMARY OF THE INVENTION

According to a first aspect of the invention there is provided a valve for regulating the flow of an ice slurry, the valve including;
a conduit defining an inlet port and an outlet port, wherein the inlet port and outlet port are each adapted to provide one or more openings, at least one opening at each port having a cross sectional area of at least substantially 80 mm²; and
a stopper portion; and
two or more ribs supporting the stopper portion relative to the conduit, the ribs configured to include a space between two or more ribs of substantially at least 80 mm²,
wherein the stopper portion and conduit move relatively between a stopped configuration, in which the inlet port is in sealing contact with the stopper portion, and an open configuration, in which the inlet port is removed from the stopper portion and the inlet port and space between the ribs are fluidly connected.

Preferably, the ribs directly or indirectly support the conduit in position and are configured to guide the conduit between the open and closed configurations.

Preferably, the valve includes three ribs evenly spaced around a stopper portion.

Preferably, the ribs are directly connected to the stopper portion.

More preferably, the three ribs define an open space between each rib of 100 mm²-400 mm².

Preferably, the inlet and outlet ports define an opening having a cross sectional area of 100 mm²-400 mm².

In further preferred embodiments, the inlet and outlet ports are circular.

Even more preferably, the inlet and outlet ports define an opening having a cross sectional area of 250 mm² to 350 mm².

Preferably, the stopper portion and inlet port are connectable using an interference fit, friction fit or clip fit mechanism.

In alternative embodiments the stopper portion and/or inlet port comprise a seal portion.

Preferably the outlet port comprises a mouthpiece. More preferably, the mouthpiece is shaped ergonomically and is formed from a material having a soft feel on the lips.

Preferably one or more of the valve components are made from silicone. Even more preferably, the stopper portion and inlet port are made from silicone to ensure an effective interference fit between the two components.

According to a second aspect of the invention there is provided a lid adapted to connect directly or indirectly to a bottle or container, the lid comprising;
a conduit defining an outlet port located on a first side of the lid and an inlet port located on a second side of the lid, wherein the inlet port and outlet port are each adapted to provide one or more openings, at least one opening at each port having a cross sectional area of at least substantially 80 mm²;
a cover portion;
a stopper portion; and
two or more ribs directly or indirectly supporting the stopper portion relative to the conduit, the ribs configured to include a space between two or more ribs of substantially at least 80 mm²,
wherein the stopper portion and conduit move relatively between a stopped configuration, in which the inlet port is in sealing contact with the stopper portion, and an open configuration, in which the inlet port is removed from the stopper portion and the inlet port and space between the ribs are fluidly connected.

Preferably, the ribs are integrally formed with the cover portion of the lid.

More preferably, the lid includes three ribs evenly spaced around a stopper portion.

More preferably, the three ribs define an open space between each rib of 100 mm²-400 mm².

Preferably, the stopper portion and inlet port are connectable using an interference fit, friction fit or clip fit mechanism.

Preferably, the inlet and outlet ports define an opening having a cross sectional area of 100 mm²-400 mm².

In further preferred embodiments, the inlet and outlet ports are circular.

Even more preferably, the inlet and outlet ports define an opening having a cross sectional area of 250 mm² to 350 mm².

Preferably, stopper portion and inlet port are connectable using an interference fit, friction fit or clip fit mechanism.

More preferably, the stopper portion and/or inlet port comprise a seal portion.

Preferably, the lid includes a mouthpiece.

Preferably, at least a portion of the lid is made from silicone.

Preferably, the conduit includes a flange located at or near the inlet port, the flange adapted to abut the underside of the lid to prevent the conduit disengaging from the lid.

According to a third embodiment of the invention, there is provided a lid adapted for attachment to a drinking bottle or container, the lid comprising a valve as previously described.

According to a fourth aspect of the invention there is provided an ice slurry delivery system, the system including;
a bottle;
a valve, wherein the valve includes a conduit defining an inlet port and an outlet port, wherein the inlet port and outlet port are each adapted to provide one or more openings, at least one opening at each port having a cross sectional area of at least substantially 80 mm², and a stopper portion, wherein the stopper portion and conduit move relatively between a stopped configuration, in which the inlet port is in sealing contact with the stopper portion, and an open configuration, in which the inlet port is removed from the stopper portion to provide a fluid pathway of at least 80 mm² between the stopper portion and the inlet port; and
a lid adapted to connect directly or indirectly to the bottle and wherein the lid is adapted to receive at least a portion of the valve to provide a fluid pathway between a first side of the lid and a second side of the lid.

In preferred embodiments, the two or more ribs are adapted to connect to the stopper portion at a first end and directly or indirectly to the underside of the lid at a second end.

In alternative embodiments, the two or more ribs connect to the stopper portion at a first end and directly or indirectly to the side of the bottle at a second end.

In preferred embodiments of the invention the bottle comprises two or more walls enclosing an air space.

More preferably, the bottle comprises two silicone walls enclosing an air space. Even more preferably the silicone walls are separated by a plurality of ribs within the air space.

In alternative embodiments the two silicone walls include a first outer wall and a second removable inner wall enclosing an air space there between.

Preferably, the second removable inner wall is in the form of a removable bladder.

More preferably, the bladder is formed from silicone.

In further preferred embodiments the ice slurry delivery system further includes a connection means adapted to directly or indirectly connect the inner walls of a removable bladder, the outer walls of the bottle and the lid.

In preferred embodiments the bottle walls are adapted to maintain an internal bottle temperature of between −1° C. and 10° C. for a period between 90 minutes and three hours, dependent on the ambient conditions.

In alternative embodiments, the outer wall comprises metallic or reflective materials moulded within the silicone.

In further alternative embodiments the outer wall includes a reflective coating.

In further alternative embodiments the outer wall includes areas of silicone or other material to aid gripping or holding the bottle.

In further alternative embodiments the outer wall includes areas containing a temperature indicator.

Preferably the temperature indicator indicates the temperature of the fluid inside the bottle.

Alternatively the temperature indicator indicates the temperature of the user of the bottle. In this embodiment the temperature of a user's hand may cause a colour change in the temperature indicator on the bottle, indicating to the user they need to consume more fluid or ice slurry from the bottle for example.

In preferred embodiments, the lid is attached directly or indirectly to the bottle via a screw mechanism.

In the alternative embodiment of the invention when the stopper portion is connected to the bottle walls by the two or more ribs, the lid includes a connection mechanism adapted to enable the inlet port to come into sealed contact with the stopper portion when the conduit is in a stopped configuration and the lid is connected to the bottle.

In the preferred embodiment, the stopper portion is connected to the inner walls of the bottle at a height to enable the inlet port to come into sealed contact with the stopper portion when the conduit is in a stopped configuration and the lid is attached to the bottle.

In alternative embodiments, the bottle used in the system of the present invention may include any number of internal ribs or protrusions to aid in maintaining the slurry at a preferred consistency. These protrusions may help facilitate stirring of the slurry when the bottle is agitated, or may provide a surface on which ice crystals may form if the bottle was placed in a freezer environment.

For the purposes of this invention the term “ribs” should be taken to mean any supporting structure that has at least one area in the form of an elongated band, strip or ridge. The ribs used within the invention should be formed of any material strong enough to support the stopper portion in position, either individually or collectively.

The term “port” when used in the context of this invention should be taken to mean an aperture or opening of any shape.

The term “conduit” should be given its normal meaning in the art, that being a tube or channel for conveying fluids, gas or other material through.

The term “slurry” used within the specification is intended to mean a mixture of small solid particles held within a liquid phase. An “ice slurry” typically used in the context of the invention may be a phase changing refrigerant made up of millions of ice micro-crystals (typically 0.1 to 1 mm in diameter) formed and suspended within a solution of water and a freezing point depressant. This however is not intended to be limiting, but is an example of drinkable ice slurry that may be used by athletes to provide hydration and electrolyte replacement while cooling body temperature.

### BRIEF DESCRIPTION OF DRAWINGS

Further aspects of the present invention will become apparent from the following description which is given by way of example only and with reference to the accompanying drawings in which:

FIGS. 1 and 1a show the valve and lid of the first, second and third aspects of the invention in a preferred embodiment, wherein the valve is in an open configuration;

FIGS. 2 and 2a show the valve and lid of the first, second and third aspects of the invention in a preferred embodiment as shown in FIG. 1, wherein the valve is in a closed configuration;

FIGS. 3 and 3a show a side view and cross section of the lid and valve of FIG. 1, wherein the valve is in an open configuration;

FIGS. 4 and 4a show a side view and cross section of the lid and valve of FIG. 2, wherein the valve is in a closed configuration;

FIG. 5 shows a lower elevation of the valve and lid of FIGS. 1-4a;

FIG. 6 shows an upper elevation of the valve and lid of FIGS. 1-5;

FIGS. 7 and 7a show an exterior view and vertical cross-section of the ice slurry delivery system in accordance with the fourth aspect of the invention;

FIG. 8 shows a cross section of the upper portion of the ice slurry delivery system of FIGS. 7 and 7a;

FIG. 9 shows a perspective view of the ice slurry delivery system of FIGS. 7-8 in a preferred form of the invention; and

FIG. 10 shows an exploded view of the ice slurry delivery system in a preferred form of the invention including a removable inner bladder and connection means between the bottle and the lid.

### DETAILED DESCRIPTION OF THE INVENTION

The valve, lid and ice slurry delivery system of the present invention have been designed to effectively store and deliver a particulate ice slurry mixture to a user of the bottle in an effective manner.

Current drinking systems known in the art are designed to deliver volumes of fluid, in particular water, from the bottle to the user in an amount required for the user to take a full mouthful. These known bottles are effective for this purpose, but become less effective, or not effective at all, when the fluid in the bottle is replaced with a particulate ice slurry.

Ice slurry drinks are created when an amount of particulate ice is held in a fluid solution, creating a flowable “slurry” of ice. When used in a standard water bottle, the ice particles become trapped within the valve mechanism. This either allows only the liquid portion of the slurry to flow though the valve, or prevents any slurry from flowing through at all.

Typical water bottles are also not designed to keep an ice slurry cool, which is essential to prevent the ice crystals from melting and becoming liquid.

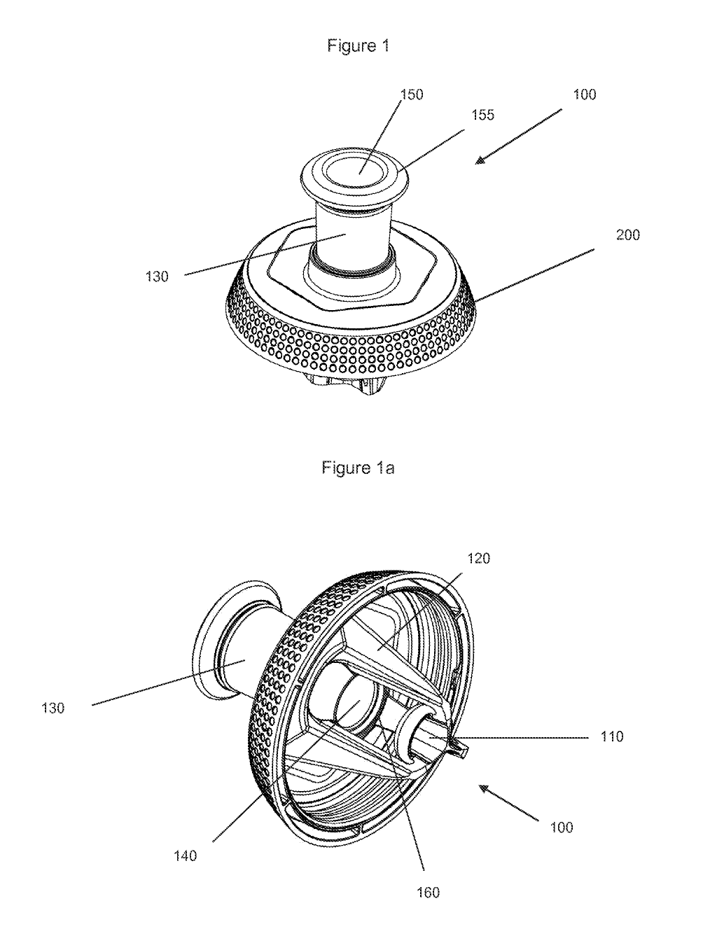

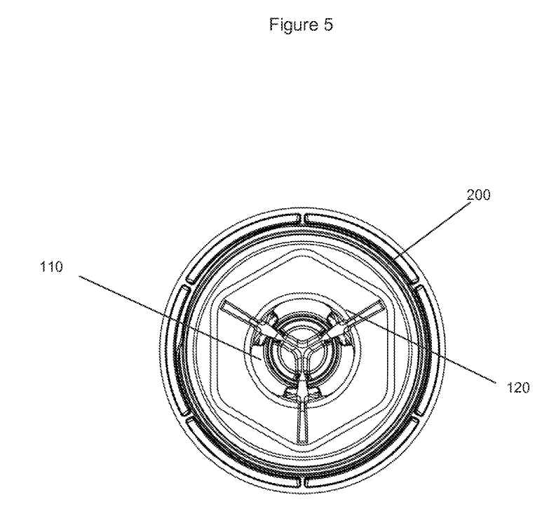

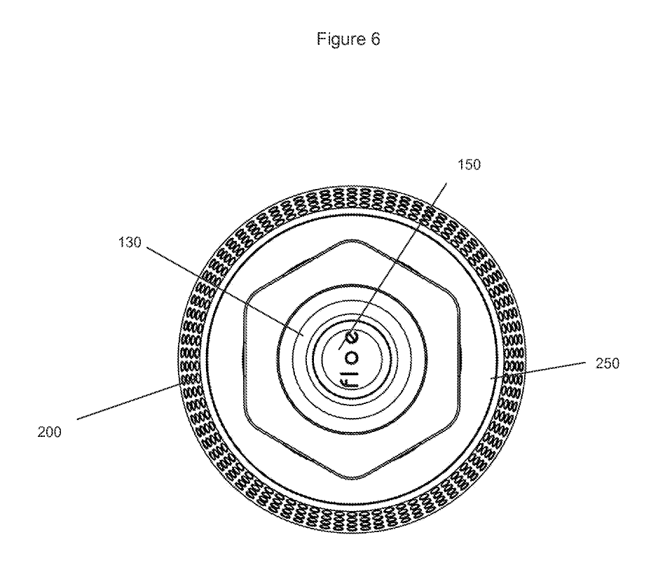

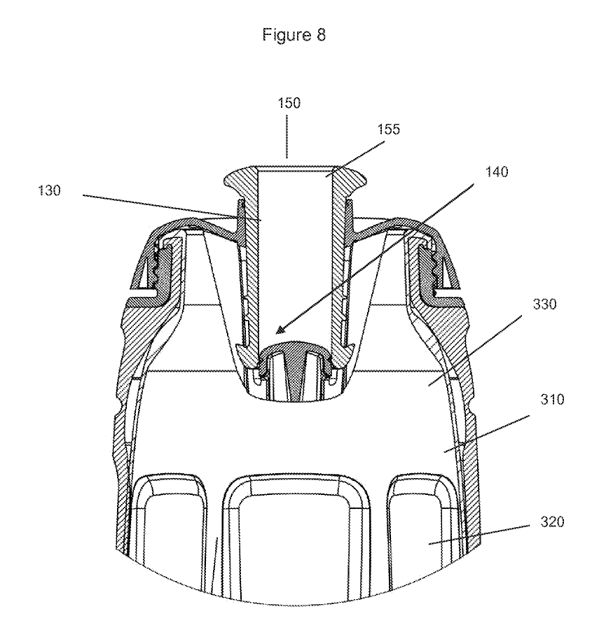

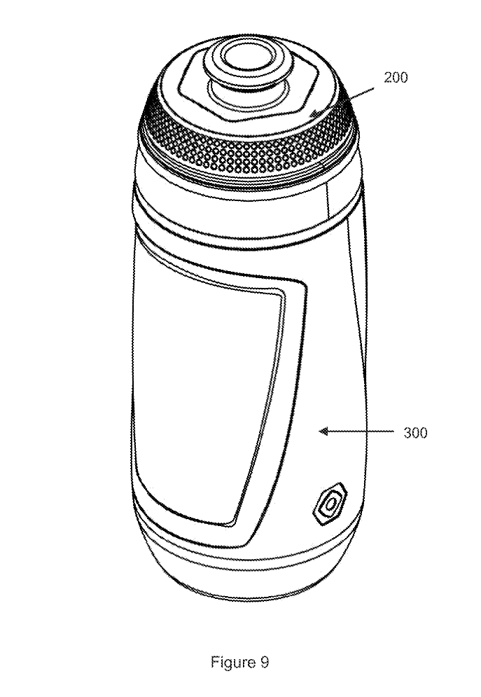

The current application addresses these issues by providing a system that enables ice slurry to move through a valve to a user without blockages. The preferred form of the invention is discussed further below with reference to FIGS. 1-10.

FIG. 1 shows a valve 100 and lid 200 of the present invention in an open position. Stopper portion 110 is held in position by three vertical ribs 120. Ribs 120 are connected to the underside of lid 200, surrounding a void (not visible) in the centre of lid 200. Ribs 120 are spaced approximately 15 mm apart and approximately 25 mm in length and define a space into which conduit 130 can insert and retract.

It is envisaged that any number of ribs greater than two may be used to hold stopper portion 110 in position, provided the ribs do not hinder the flow of ice slurry to the inlet port from the bottle.

In the current embodiment shown in FIGS. 1-6, ribs 120 are connected to the underside of lid 200 in a substantially vertical orientation. This is not however intended to be limiting, as ribs 120 may angle outwards and connect closer to the rim of lid 200 in order to create a larger space between the ribs. Alternatively the ribs may be of varying lengths in order to accommodate conduits of different lengths.

Conduit 130 comprises an inlet port 140 and outlet port 150. Inlet port 140 is designed to connect to stopper portion 110 via an interference fit, or clip fit to form a seal capable of preventing the flow of ice slurry into conduit 130 when valve 100 is in a closed position.

Conduit 130 preferably has a cross sectional area of 80 mm² or more to ensure the flow of ice slurry in continuous movement from within the bottle. Conduits with a cross sectional area of approximately 200 mm² have been shown to be particularly effective in delivery of ice slurry. Larger cross sectional areas will produce greater flows of ice slurry as would be clear to a person skilled in the art. The length of the conduit may also vary, allowing the outlet port to be at a range of distances from lid 200 when valve 100 is in the open position. In some instances it may be useful to have a longer conduit so the bottle does not need to be brought so close to the mouth, whereas for other uses, the conduit may require a short distance.

One example of where a very long conduit may be used would be in the application of the valve to a hydration pack or similar, where the container carrying the fluid is located some distance from the mouthpiece.

Outlet port 150 is located on the exterior of lid 200 and provides an outlet for the ice slurry from a bottle. In preferred embodiments of the invention outlet port 150 includes a mouthpiece 155. Mouthpiece 155 may be in any form as would be known in the art, but preferably includes features such as a rim or flange to enable the user to easily withdraw conduit 130 from lid 200 using their hands or mouth as required. The presence of a rim or flange also reduces spillage from the valve when drinking. In further preferred embodiments the mouthpiece is formed from silicone.

Both inlet port 140 and outlet port 150 have a minimum cross sectional area of approximately 80 mm². This area is larger than typical valve systems known in the art and is approximately the minimum size necessary to effectively facilitate flow of ice slurry through the valve to the user without blockage caused by ice particle build-up. Valve systems of this size are not suitable for use with standard drinking fluids such as water, particularly when the user is an athlete or someone who requires a drink to be taken often in small quantities. The large valve makes it difficult to take controlled sips without spilling due to the high flow level. When used with ice slurry however, the greater valve size enables the slurry to flow uninhibited, but the slower flow speed of the slurry compared to water means spillage is limited.

In preferred forms of the invention the inlet and outlet ports have a cross sectional area of approximately 200 mm². While this is a preferred size, it is not intended to be limiting and the inlet and outlet ports may alter in size depending on the bottles intended use or target market.

Ribs 120 are positioned a distance from one another to allow unimpeded flow of ice slurry from within a bottle though inlet port 140 and out outlet port 150 when valve 100 is in an open configuration. The positioning of ribs 120 may vary in both number and location, but as would be clear to a person skilled in the art, ribs 120 must be positioned in such a way as to not obstruct the flow of ice slurry into inlet port 140. In the embodiments shown in FIGS. 1-6, the lid/valve includes 3 ribs defining a space of 308 mm² between each of the ribs, allowing an uninterrupted flow of slurry from the bottle to the inlet port 140 of conduit 130.

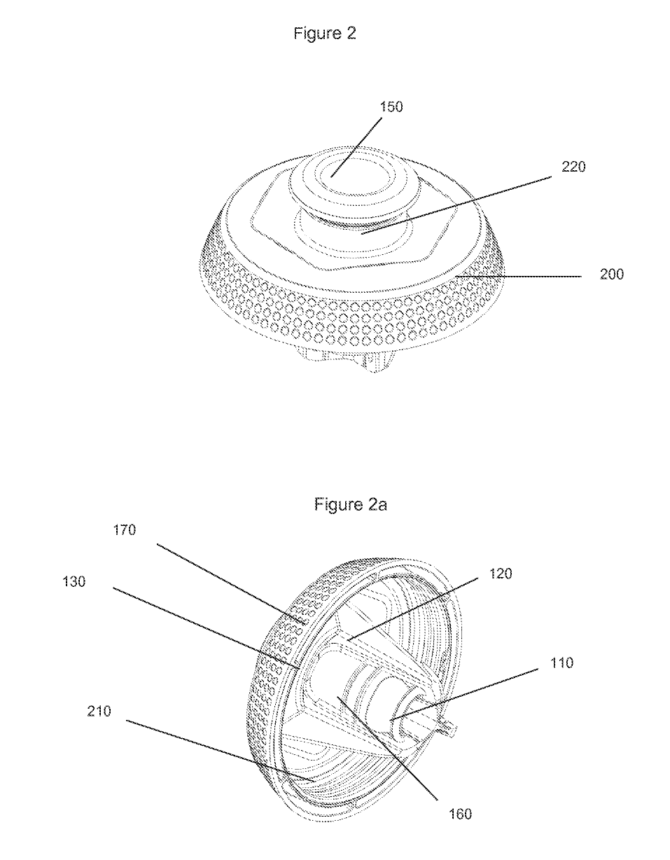

FIG. 2 shows valve 100 and lid 200 wherein the valve is in a closed configuration. When closed inlet port 140 is inserted towards the underside of lid 200 by applying downward pressure to outlet valve 150, the downward pressure forces conduit 130 downwards until inlet port 140 connects to stopper portion 110, creating a firm seal using known methods.

Flange 160 is located on the exterior of conduit 130. When valve 100 is moved from a closed position to an open position by pulling outlet valve 150 upwards, flange 160 abuts face 170 preventing conduit 130 from disengaging with lid 200.

Lid 200 further includes an attachment means 210 for securing the lid to a bottle or other drinking apparatus. Preferably this attachment means is in the form of a screw mechanism, however other know means of connecting a lid may be used such as clip fit mechanisms, clasps or hinges for example. Lid 200 also includes a neck portion 220 in preferred embodiments. Neck portion 220 provides additional support to conduit 130.

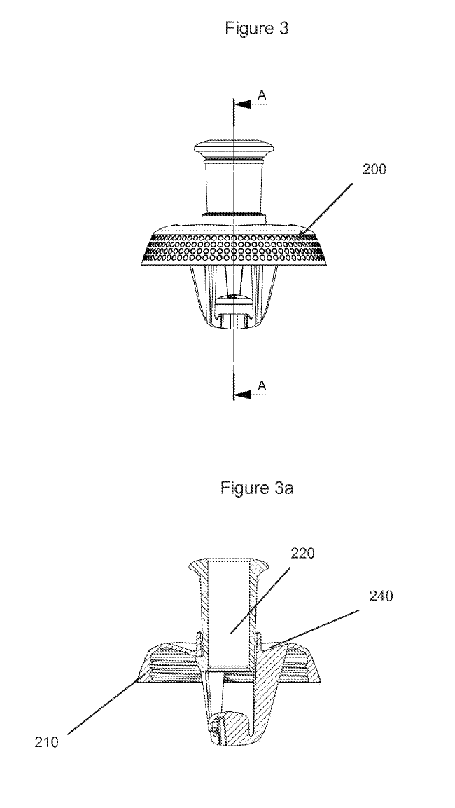

FIGS. 3, 4, 5 and 6 show cross section and plan views of the preferred embodiments of FIGS. 1 and 2.

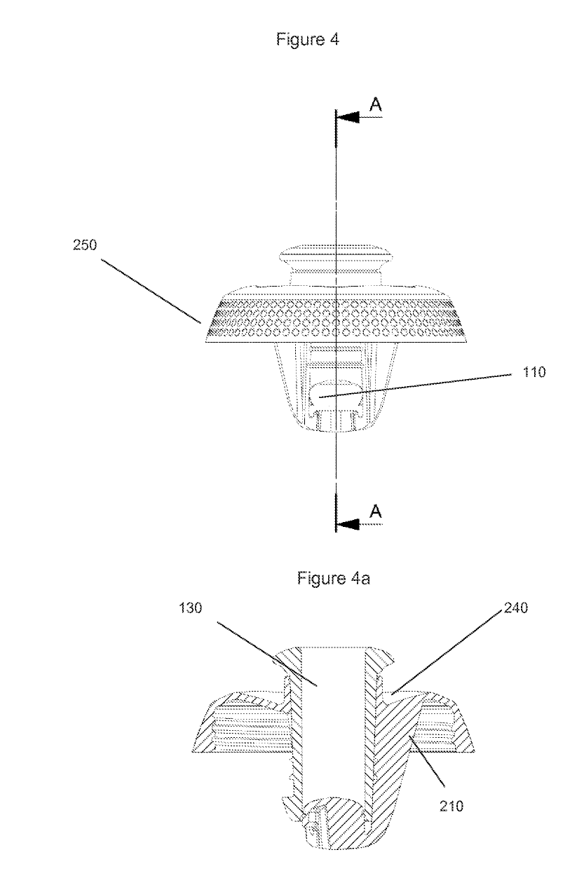

As shown in FIGS. 3 and 4, lid 200 includes a surface 240 that acts as a lid cover, maintaining the ice slurry within a bottle when lid 200 is attached to a bottle via threaded portion 210. Surface 240 further acts to support neck 220 in position, which in turn provides a pathway for conduit 130.

FIGS. 3 and 4 also show corrugations 250 on the outer rim of lid 200, enabling a firm grip to be achieved when screwing the lid on and off a bottle in known fashion.

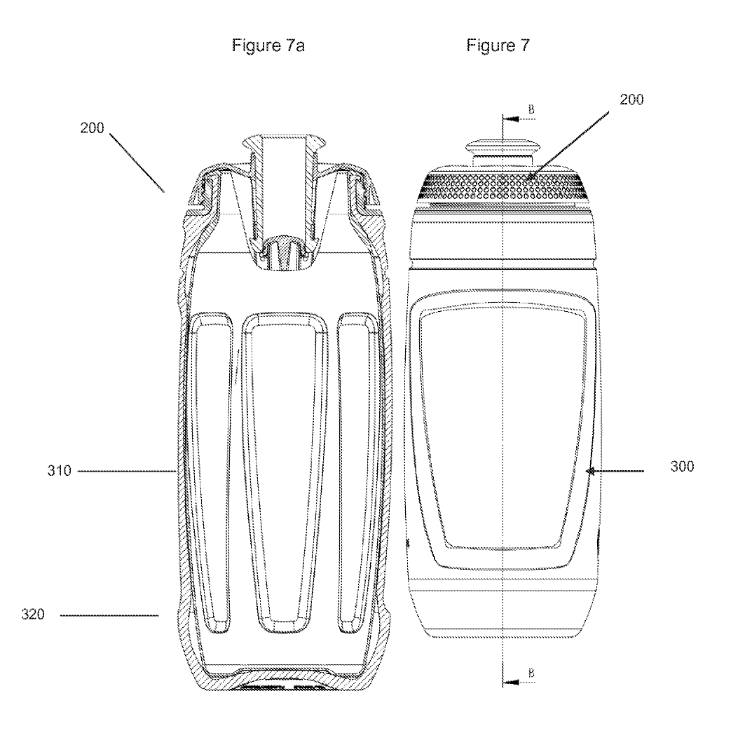

The drinking bottle system of the present invention is shown in a preferred embodiment in FIGS. 7, 8, 9 and 10 and includes the valve and lid embodiments as described above with reference to FIGS. 1-6 together with an insulated bottle 300.

Insulated bottle 300 includes an inner wall 320 and outer wall 310 enclosing a vacuum pocket 330. Bottle 300 works in a similar fashion to a standard vacuum flask, the vacuum pocket preventing heat transfer between the inside of the bottle and the external environment. The size of the vacuum pocket may vary to provide optimum insulation levels. In other embodiments the pocket 330 may hold air or other gas as an alternative to a vacuum.

The ability of the bottle to insulate the contents from the temperature of the external environment is essential in keeping the ice slurry in a slurry form. As the contents of the bottle heat up, the ice slurry will melt and the contents of the bottle will eventually return to liquid form. It is envisaged that the drinking bottle system of the present invention will be utilised by athletes as a means of reducing body/brain temperature while simultaneously hydrating the body. It is therefore preferable to maintain ice slurry in a frozen or partially frozen form for at least two hours. This length of time enables ice slurry to be successfully delivered to athletes participating in long distance endurance events or events requiring a significant amount of time in a warm environment.

Preferably walls 310 and 320 are created from a resilient silicone material to allow the bottle to be squeezed and return to its original shape. However, other materials may be used to form the bottle walls as would be clear to a person skilled in the art.

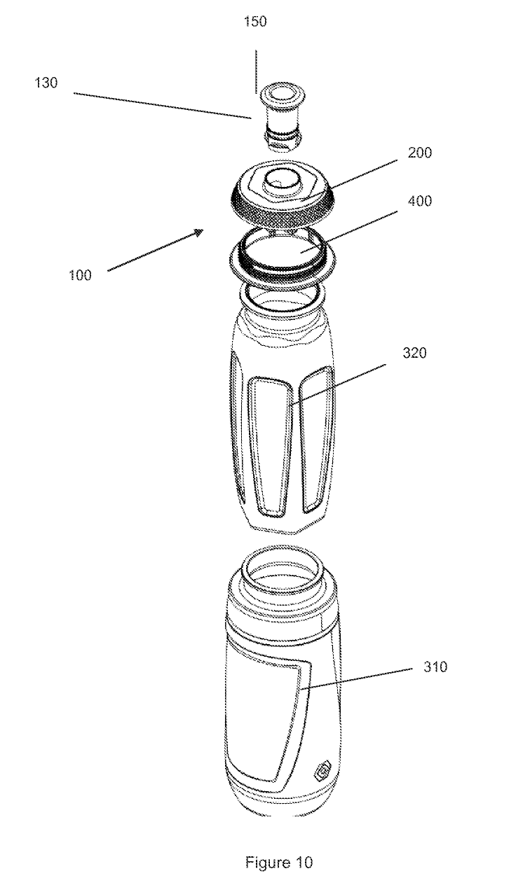

In embodiments shown in FIGS. 7, 8 and 10, inner wall 320 is in the form of a removable silicone bladder. FIG. 10 shows an exploded view where removable bladder 320 can be clearly seen.

Outer wall 310 may include reflective particles moulded within the silicone material, or a reflective covering to further increase the insulating properties of the bottle.

FIG. 10 further shows connection means 400. In the embodiment shown, connection means 400 is in the form of a silicone ring. Ring 400 is adapted to receive the upper rim of removable bladder 320 and additionally fit securely over the neck of bottle 300. Ring 400 may also include a screw thread in order to receive lid 200 and maintain the ice slurry within the bladder 320.

The use of the connection means 400 is optional and the use of connection means 400 will be dictated by the shape and type of connection used to attach lid 200 to bottle 300. Any number of bottle/lid combinations, with or without an additional connection means as known in the art are envisaged by the applicant.

In other embodiments the drinking bottle system may include areas of temperature indication. Temperature indication areas are useful for both monitoring the internal temperature of the bottle and its contents, and monitoring the temperature of the user.

When monitoring the internal temperature of the drink bottle, a temperature indicator may show when it would be time to place the bottle in a freezer if it was becoming too warm. Such an indicator may be present on the lid, valve or body of the bottle and would use known temperature monitoring techniques.

Similarly, such a temperature indicator may be present on the exterior of the bottle in order to assess an approximate temperature of a user based on hand warmth or similar body heat measurement. This would be particularly beneficial to athletes who could identify if their body temperature need reducing, thereby prompting them to consume more ice slurry in order to bring down their core body temperature.

The valve, lid and drinking bottle system of the present invention has a number of advantages over known products available.

Current bottle valve systems are designed around the delivery of a fluid to a user. The rheological properties of ice slurry are vastly different to those of a fluid such as water and as such require a valve with dimensions and form to accommodate these differences.

The current invention provides a way to deliver ice slurry to a user without the risk of blockages, separation of the contents of the slurry or intermittent flow. The design and dimensions of the valve of the present invention allow flow of ice slurry from a bottle to the user without the risk of blockages and at a flow rate great enough to provide delivery at a consistent and adequate rate.

For high performance athletes in particular, cooling and hydration is a critical factor in maintaining peak performance. It is therefore essential that they have access to ice slurry in a simple and timely fashion.

The incorporation of an insulating bottle allows the slurry to be maintained at a low temperature for an extended period of time, providing a method of providing cooling in a simple, portable manner. When combined with the lid and valve of the current invention, an effective ice slurry delivery system is created.

Aspects of the present invention have been described by way of example only and it should be appreciated that modifications and additions may be made thereto without departing from the scope thereof.

1. A valve for regulating the flow of an ice slurry, the valve including;
a conduit defining an inlet port and an outlet port, wherein the inlet port and outlet port are each adapted to provide one or more openings, at least one opening at each port having a cross sectional area of at least substantially 80 mm²;
a stopper portion; and
two or more ribs directly or indirectly supporting the stopper portion relative to the conduit, the ribs configured to include a space between two or more ribs of substantially at least 80 mm²,
wherein the stopper portion and conduit move relatively between a stopped configuration, in which the inlet port is in sealing contact with the stopper portion, and an open configuration, in which the inlet port is removed from the stopper portion and the inlet port and space between the ribs are fluidly connected.

2. The valve as claimed in claim 1, wherein the ribs directly or indirectly support the conduit in position and are configured to guide the conduit between the open and closed configurations.

3. The valve as claimed in claim 1, wherein the valve includes three ribs evenly spaced around a stopper portion.

4. The valve as claimed in claim 1, wherein the ribs define an open space between each rib of 100 mm²-400 mm².

5. A lid adapted to connect directly or indirectly to a bottle or container, the lid comprising;
a conduit defining an outlet port located on a first side of the lid and an inlet port located on a second side of the lid, wherein the inlet port and outlet port are each adapted to provide one or more openings, at least one opening at each port having a cross sectional area of at least substantially 80 mm²;
a cover portion;
a stopper portion; and
two or more ribs directly or indirectly supporting the stopper portion relative to the conduit, the ribs configured to include a space between two or more ribs of substantially at least 80 mm²,
wherein the stopper portion and conduit move relatively between a stopped configuration, in which the inlet port is in sealing contact with the stopper portion, and an open configuration, in which the inlet port is removed from the stopper portion and the inlet port and space between the ribs are fluidly connected.

6. The lid as claimed in claim 5, wherein the ribs are integrally formed with the cover portion of the lid.

7. The lid as claimed in claim 5, wherein the lid includes three ribs evenly spaced around a stopper portion.

8. The lid as claimed in claim 5, wherein the ribs define an open space between each rib of 100 mm²-400 mm².

9. The lid as claimed in claim 5, wherein the conduit includes a flange located at or near the inlet port, the flange adapted to abut the underside of the lid to prevent the conduit disengaging from the lid.

10. A lid adapted for attachment to a drinking bottle or container, the lid comprising a valve as claimed in claim 1.

11. A ice slurry delivery system, the system including;
a bottle;
a lid adapted to connect directly or indirectly to the bottle; and
a valve wherein the valve includes a conduit defining an inlet port and an outlet port, wherein the inlet port and outlet port are each adapted to provide one or more openings, at least one opening at each port having a cross sectional area of at least substantially 80 mm², and a stopper portion, wherein the stopper portion and conduit move relatively between a stopped configuration, in which the inlet port is in sealing contact with the stopper portion, and an open configuration, in which the inlet port is removed from the stopper portion to provide a fluid pathway of at least 80 mm² between the stopper portion and the inlet port.

12. The ice slurry delivery system of claim 11, wherein, the lid or valve includes two or more ribs adapted to connect to the stopper portion at a first end of the ribs and directly or indirectly to the lid or conduit at a second end of the ribs.

13. The ice slurry delivery system of claim 11, wherein the two or more ribs connect to the stopper portion at a first end of the ribs and directly or indirectly to the side of the bottle at a second end of the ribs

14. The ice slurry delivery system of claim 11, wherein the bottle comprises two or more walls enclosing an air space.

15. The ice slurry delivery system of claim 11, wherein the two walls include a first outer wall and a second removable inner wall enclosing an air space there between.

16. The ice slurry delivery system of claim 11, wherein, the second removable inner wall is in the form of a removable bladder.

17. The ice slurry delivery system of claim 11, wherein the outer wall of the bottle includes areas containing a temperature indicator.

18. The ice slurry delivery system of claim 11, wherein when the stopper portion is connected to the bottle walls by the two or more ribs, the lid includes a connection mechanism adapted to enable the inlet port to come into sealed contact with the stopper portion when the conduit is in a stopped configuration and the lid is connected to the bottle.

19. The ice slurry delivery system of claim 11, wherein the bottle includes internal ribs or protrusions to aid in maintaining the slurry at a preferred consistency.
